(19) United States
(12) Patent Application Publication
(10) Pub. No.: US 2006/0257297 A1
(43) Pub. Date: Nov. 16, 2006

(54) Honeycomb body having at least one space-saving measurement sensor, and corresponding lambda sensor

(75) Inventors: Rolf Bruck, Bergisch Gladbach (DE); Kait Althofer, Wiehl (DE)

Correspondence Address: LERNER GREENBERG STEMER LLP, P O BOX 2480, HOLLYWOOD, FL, 33022-2480, US

(73) Assignee: Emitec Gesellschaft fur Emissionstechnologie m.b.H.

(21) Appl. No.: 11/451,029

(22) Filed: Jun. 12, 2006

Related U.S. Application Data
(63) Continuation of application No. PCT/EP04/13757, filed on Dec. 3, 2004.

(30) Foreign Application Priority Data
Dec. 11, 2003 (DE) DE 103 57 951.6

(51) Int. Cl. B01J 21/04; B01D 50/00

(52) U.S. Cl. 422/177; 502/439

(57) ABSTRACT

A honeycomb body, which can be traversed by a fluid, in particular the exhaust gas of an internal combustion engine, at least partially in a through-flow direction, includes a plurality of at least partially traversable cavities that form a honeycomb structure located in a casing. At least one sensor has at least first and second subsections. At least the second subsection extends into the honeycomb structure and penetrates at least part of the cavities. At least the first subsection extends beyond the casing. The first and second subsections are substantially rigid and form an angle other than 180 degrees in a first plane is encompassing the through-flow direction and/or a second plane perpendicular to the through-flow direction. The angled construction of the sensor permits the honeycomb body to have a space-saving construction that includes at least one sensor. A lambda sensor for installation in a honeycomb body is also provided.

### CROSS-REFERENCE TO RELATED APPLICATIONS

This is a continuing application, under 35 U.S.C. §120, of copending International Application No. PCT/EP2004/013757, filed Dec. 3, 2004, which designated the United States; this application also claims the priority, under 35 U.S.C. §119, of German Patent Application DE 103 57 951.6, filed Dec. 11, 2003; the prior applications are herewith incorporated by reference in their entirety.

### BACKGROUND OF INVENTION

### Field of the Invention

The present invention relates to a honeycomb body having at least one measurement sensor, which can be used in particular as a catalyst carrier body for converting at least parts of the exhaust gas from an internal combustion engine. The invention also relates to a corresponding lambda sensor.

Components of the exhaust gas from internal combustion engines of automobiles have long been classified as harmful to health and the environment. For some time, many countries throughout the world have issued statutory limits which must not be exceeded by those exhaust-gas components. Compliance with those limits is generally achieved by catalytic conversion of at least parts of the exhaust gas. That requires the largest possible surface area at which the reaction can take place, combined with the smallest possible space requirement for accommodating the catalytic converter. Those two conditions are often satisfied by honeycomb bodies which serve as catalyst carrier bodies. Two basic forms of such honeycomb bodies are generally known, namely ceramic and metallic honeycomb bodies. The metallic honeycomb bodies are often wound helically or stacked and intertwined, for example in an S-shape or in involute form, from metallic layers. Metallic honeycomb bodies of that type, composed of layers, are often at least partially formed from at least partially structured metallic layers and substantially smooth metallic layers. The structures of the layers form cavities, for example passages, when the honeycomb body is assembled. The exhaust gas uses those cavities to flow through the honeycomb body. Ceramic honeycomb bodies, for example, are extruded in such a way as to form passages through which the exhaust gas can flow. A catalytically active material is applied to the cavity walls, for example in the form of precious metal particles, such as for example platinum or rhodium particles in a ceramic coating, such as for example a washcoat.

The increasing stringency of emission limits in many countries leads to increased demands being imposed on the catalyst carrier body. In particular, statutory regulations require analysis of the exhaust gas during operation to monitor the catalytic conversion and functionality of the catalyst carrier body. On-board diagnosis (OBD) of that type requires the use of measurement sensors to monitor characteristic variables of the exhaust gas. Characteristic variables of that type include, for example, the oxygen content of the exhaust gas, which is determined by using a lambda sensor, or the temperature and proportion of components of the exhaust gas, such as for example nitrogen oxides (NOₓ) or the like. Therefore, due to the OBD, inter alia, there is a tendency to form one or more measurement sensors in the honeycomb body. However, at the same time, in particular in the case of modern automobiles, there is only a very limited installation space available for the catalyst carrier body. By way of example, German Utility Model DE 88 16 154 U1 has disclosed a carrier body for a catalytic reactor, the honeycomb body of which is formed in a single piece from metallic corrugated strips. The sensor is disposed at the carrier body in such a manner that part of the sensor extends in to the interior of the honeycomb body and part of the sensor extends outside of the honeycomb body. The sensor is rectilinear in form, with the result that the part of the sensor which lies outside the honeycomb body extends a relatively long distance away from the honeycomb body. A configuration of that type requires a relatively large amount of space during installation in the exhaust system of an automobile.

### SUMMARY OF THE INVENTION

It is accordingly an object of the invention to provide a honeycomb body having at least one space-saving measurement sensor, and a corresponding lambda sensor, which overcome the hereinafore-mentioned disadvantages of the heretofore-known devices of this general type and which simultaneously allow determination of at least one characteristic variable of the exhaust gas and a very small space requirement for the honeycomb body and the measurement sensor or lambda sensor.

With the foregoing and other objects in view there is provided, in accordance with the invention, a honeycomb body. The honeycomb body comprises a tubular casing and a honeycomb structure through which a fluid can at least partially flow in a through-flow direction. The honeycomb structure is accommodated in the tubular casing and defines a plurality of cavities through which the fluid can at least partially flow. The through-flow direction defines a first plane encompassing the through-flow direction and a second plane perpendicular to the through-flow direction. At least one measurement sensor has at least a first substantially rigid subregion and a second substantially rigid subregion. At least the second subregion extends into the honeycomb structure and at least partially penetrates through at least some of the cavities, and at least the first subregion extends outside the tubular casing. The first subregion and the second subregion include or enclose an angle other than 180 degrees in the first and/or second planes.

In this context, the term rigid means in particular that the subregions are substantially not deformable and/or elastic under forces which may occur during installation of the measurement sensor in the honeycomb body and/or forces which may occur during use of the honeycomb body in the exhaust system of an automobile; in particular as a catalyst carrier body. The through-flow direction is determined by the flow through the honeycomb body from a first end side to a second end side. In particular, it is possible and in accordance with the invention, for the fluid, in particular the exhaust gas within the honeycomb body, to locally flow in a different direction than the through-flow direction.

A honeycomb body is composed of a honeycomb structure and a tubular casing. In this case, the honeycomb structure includes the cavities of the honeycomb body and is accommodated in the tubular casing, and in general is connected to the tubular casing by a joining technique, preferably brazing or welding, but if appropriate also through the use of an intermediate element, such as a corrugated sheath or the like, at least in subregions. The honeycomb body may be cylindrical in form, but may equally well be in conical or plate form as well as, for example, honeycomb bodies which have a non-circular, for example oval or polygonal, cross section.

The first and second subregions include or enclose an angle in a first plane, which encompasses the direction of flow through the honeycomb body, and/or in a second plane, which is perpendicular to the direction of flow through the honeycomb body. The angle is therefore defined by the two subregions of the measurement sensor or by the positions of these subregions with respect to one another. In this case, the second plane is defined by being perpendicular to the direction of flow through the honeycomb body, i.e. the vector of the through-flow direction is normal to the second plane. The first plane lies perpendicular to the second plane and encompasses the vector of through-flow. It is preferable for the second plane to encompass at least the axis of the second subregion or the tangent of the second subregion in a contact region in which the first and second subregions are connected to one another.

A measurement sensor is to be understood as meaning a configuration which allows values of at least one characteristic variable of the fluid to be absorbed when the fluid flows through the honeycomb body. In this case, the characteristic variable may be any desired physical and/or chemical variable which can be determined directly and/or indirectly. Furthermore, the measurement sensor can also operate according to any desired physical and/or chemical measurement principle. Additionally, it is possible for more than one measurement sensor, in particular two, three or four measurement sensors, to be formed in the honeycomb body.

The measurement sensor also includes a data connection which can be used to tap off the recorded values for the at least one characteristic variable. This data connection may, for example, be in the form of a cable or a plug connection which allows connection of a cable. In particular, the data connection may be part of the first subregion.

In particular, the cavities in the honeycomb body may be passages which extend from the first end side to the second end side of the honeycomb body and thereby guide the fluid. However, it is also possible to form other types of cavities, for example passages which are interrupted by voids. In particular, apertures and connections of adjacent cavities are also possible. It is also possible for at least some of the cavities to each have an opening in the first end side and in the second end side. For example, the cavities may be at least partially closed, if appropriate also with a material through which a medium can at least partially flow, so as to form blind flow alleys or flow bottlenecks. Measures of this type can be taken to construct open or closed particulate filters. These are used in particular to filter the particulates, such as for example soot particulates, contained in the exhaust gas from an automobile, out of the exhaust gas. In this context, a distinction is drawn between open and closed particulate filters. In the case of closed particulate filters, all of the exhaust gas has to pass through closed passages, whereas in the case of an open particulate filter a medium can flow substantially freely through the passages. In this case, precautions are taken to ensure that the exhaust-gas stream is multiply diverted and guided through walls which at least partially allow fluid to flow through them and in which the particulates accumulate.

Furthermore, the honeycomb body according to the invention can in particular also be used as a catalyst carrier body in the exhaust system of an automobile. For this purpose, it is possible to apply a coating of ceramic material, for example a washcoat, into which the catalytically active material has been introduced. This ceramic coating leads to a further increase in the reactive surface area of the catalyst carrier body. Furthermore, the honeycomb body according to the invention can be equipped with a corresponding coating which allows it to be used as a storage medium for at least one component of the exhaust gas. This may, for example, be a coating which adsorbs nitrogen oxides (NOₓ) at low temperatures and desorbs them at higher temperatures.

The measurement sensor is in particular formed and introduced into the honeycomb body in such a way as to at least partially penetrate through a plurality of cavities of the honeycomb body. This has the result that the at least one characteristic variable is determined in the fluid which flows or can flow through these cavities. At the same time, in general an average is taken over the fluid flowing through these cavities. Depending on the particular application, it is possible and in accordance with the invention for the cavity in the honeycomb body for receiving the measurement sensor to be made as small as possible so that, therefore, the shortest possible distance is formed between the measurement sensor and the cavity boundaries. When used as a catalyst carrier body, this leads to the minimum possible loss of catalytically active surface area. In other applications, however, it may be advantageous to provide a certain free volume around the measurement sensor, in order to allow improved mixing of the fluid in this way, for example the exhaust gas from an automobile, and to obtain measured values in this way which represent an average over a relatively large part of the fluid.

The honeycomb body according to the invention advantageously allows control and monitoring of at least one characteristic variable of the fluid, while at the same time the space required for installation of the honeycomb body with the measurement sensor is small, since the angle between the first and second pieces or subregions of the measurement sensor can be selected as desired and the space required can therefore be adapted to the available spatial conditions. In this case it may be advantageous for at least one of the two pieces or subregions to be rectilinear in form or alternatively curved. Therefore, according to the invention it is possible, for example, for the second piece or subregion to be rectilinear in form, while the first piece or subregion is curved. In this case, it is advantageously possible for the curvature of the first piece or subregion to be matched to the curvature of the honeycomb body in the region from which the first piece or subregion emerges. In such a case, the angle is determined as the angle between the tangent in the contact region between the first and second subregions and the axis or tangent of the other subregion in the contact region between the two subregions.

In accordance with another feature of the invention, the at least one measurement sensor is constructed as a lambda sensor. In particular, in the case of OBD in the exhaust system of an automobile, lambda sensors form an important measurement sensor which allows the determination of the fuel/oxygen ratio. Furthermore, it is advantageous for a lambda sensor in each case to be formed upstream of the honeycomb body or in the initial region of the honeycomb body, preferably within the first 20% of the length of the honeycomb body, and for another lambda sensor to be formed in the end region, preferably within the last 20% of the length of the honeycomb body, or downstream of the honeycomb body, as seen in the through-flow direction.

In accordance with a further feature of the invention, the at least one measurement sensor includes at least one of the following characteristic variables of the fluid:

a) temperature;

b) proportion of at least one component of the fluid.

Since, when the honeycomb body according to the invention is used as a catalyst carrier body in the exhaust system of an automobile, the exhaust gas is generally at a high temperature and, moreover, the catalyzed reactions are exothermic, the temperature of the honeycomb body or of the exhaust gas flowing through it is an important characteristic variable both for the operating state and general state of the honeycomb body and for the degree of conversion which is achieved with the catalytic reaction. Furthermore, the measurement sensor may advantageously also record a proportion of at least one component in the exhaust gas, such as for example the oxygen content, the nitrogen oxide content, the ammonia content and/or the hydrocarbon content. The measured values recorded in this way can advantageously also be used to control and monitor at least the exhaust system of an automobile. In particular, it is also possible and in accordance with the invention to form combined measurement sensors which, for example, on one hand perform the function of a lambda sensor and on the other hand additionally also record the temperature and/or a proportion of a component of the exhaust gas.

In accordance with an added feature of the invention, the at least one measurement sensor has measures for impeding heat conduction. For example, a thermally insulating layer may at least partially surround it near the first subregion.

Due to the angled structure of the measurement sensor, the first subregion of the measurement sensor is closer to the honeycomb body than in the case of an unangled structure of the measurement sensor. If the honeycomb body according to the invention is used in the exhaust system of an automobile, for example as a catalyst carrier body, an adsorber body, a particulate filter, a particulate trap or alternatively as a combined element representing combinations thereof, the honeycomb body, and therefore also the measurement sensor, is exposed to high temperatures, for example up to 1000 degrees Celsius and above, depending on the position of the honeycomb body with respect to the internal combustion engine. These temperatures impose high thermal stresses on the material, in particular of the measurement sensor. According to the invention, this effect is taken into account by the formation of a thermally insulating layer in particular in the first subregion of the measurement sensor. This thermal insulation is formed in such a way that it is adapted to the high thermal transients and/or gradients which occur and the latter do not lead to rapid wear to the material of the thermal insulation under the conditions of use, for example in the exhaust system of an automobile.

In addition to these measures for thermal insulation, it is also possible to use other measures known to a person skilled in the art to impede or even prevent undesirable supply of heat from the tubular casing of the housing or from the heat structure (for example also through thermal radiation) to temperature-sensitive subregions of the measurement sensor.

In accordance with an additional feature of the invention, the angle included by the first subregion and the second subregion amounts to 60 to 120 degrees, preferably 75 to 105 degrees, and particularly preferably 85 to 95 degrees.

In particular, in an embodiment in which the angle has at least a component in a plane that encompasses the direction of flow through the honeycomb body, angles of less than 90 degrees are advantageous. In general, an angle of 90 degrees allows the minimum possible space to be taken up by the installation of a honeycomb body including measurement sensors. Angles of more than 90 degrees may also be advantageous if the angle has at least a component in a plane which encompasses the through-flow direction. Angles of this type reduce wear problems in these regions caused by heating of the first piece or subregion and in particular of data connections formed in the first subregion.

In accordance with yet another feature of the invention, the angle included by the first subregion and the second subregion amounts to substantially 90 degrees. A substantially right angle advantageously leads to a very space-saving installation of the honeycomb body and the measurement sensor.

In accordance with yet a further feature of the invention, at least one subregion of the measurement sensor is at least partially curved. In particular, if the first subregion is curved, this allows further space-saving options since, for example, the measurement sensor may be curved in such a way that there is a free space between the first subregion and the outer side of the tubular casing of the honeycomb body, which increases in size toward the outside from the location where the measurement sensor is received. This too advantageously allows the problems caused by the heating of the measurement sensor to be alleviated. Furthermore, it is also possible to configure the curvature of the first subregion in such a way that it bears closely against the outer side of the tubular casing of the honeycomb body. This leads to further space saving, since the measurement sensor, as it were, nestles against the honeycomb body. In this case, sufficient thermal insulation is provided, substantially preventing thermal damage to the measurement sensor. In such a situation, the angle included by the first and second subregions is determined as the angle between the tangent in the contact region between first and second subregions and the axis or tangent of the other subregion.

In accordance with yet an added feature of the invention, the curvature of the curved subregion is matched to a curvature of the honeycomb body and/or to geometric conditions in the honeycomb body.

Matching the curvature of the first subregion to the outer curvature of the honeycomb body or of the tubular casing of the honeycomb body is advantageous since this leads to the maximum possible space saving. Furthermore, matching the curvature of the second subregion to the geometric conditions in the honeycomb body allows a very controlled selection of the parts of the fluid having measured values which are recorded by the measurement sensor. Matching to the geometric conditions in the honeycomb body means, for example, that if the honeycomb body is formed from at least partially structured metallic layers and substantially smooth metallic layers, which are intertwined in involute form, the second subregion also has a substantially involute form. For example, it is in particular possible to select specific partial-flows in which the measured values are recorded.

In accordance with yet an additional feature of the invention, the honeycomb body is at least partially formed from at least one metallic layer.

Forming the honeycomb body from metallic layers, for example sheet-metal layers and/or metallic fiber layers, preferably from thermally stable and corrosion-resistant metals, for example thermally stable steels, advantageously makes it possible to construct honeycomb bodies which are able to withstand even the harsh conditions encountered in the exhaust system of an automobile. Moreover, forming the honeycomb body from metallic layers allows a very variable configuration in particular of the cavities in the honeycomb body. In the present context and in the text which follows, a metallic layer is deemed to encompass not only a layer which is composed of a single material, i.e. for example a sheet-metal layer or a layer through which a fluid can at least partially flow, for example a layer of metallic fiber material, but also a layer which is composed of a plurality of materials or regions, for example a layer which has regions made from sheet metal and regions made from metallic fiber material. This in particular also encompasses metallic fiber layers which are reinforced by at least one strip of sheet metal or also have just individual regions that are catalytically coated.

In accordance with still another feature of the invention, the honeycomb body is composed of a plurality of at least partially structured metallic layers and substantially smooth metallic layers, which are stacked and intertwined or wound up.

In this case, it is advantageous, for example, for two metallic layers to be wound up helically, one of which is at least partially structured, for example corrugated, and the other of which is substantially smooth. In the case of helically winding up these two layers, the interaction of the structures with the substantially smooth metallic layers gives rise to a plurality of passages which extend over the entire length of the honeycomb body.

In accordance with still a further feature of the invention, at least one at least partially structured layer is stacked with at least one substantially smooth layer and at least one stack is twisted. In this way it is possible, for example, for two stacks to be intertwined in opposite directions in an S-shape or for three stacks to be intertwined in involute form.

A substantially smooth layer is to be understood as meaning a layer which may optionally have microstructuring, the amplitude of which, however, is smaller, preferably significantly smaller, than the structuring amplitude of the at least partially structured metallic layer.

In accordance with still an added feature of the invention, the honeycomb body is wound up from at least one at least partially structured metallic layer and, if appropriate, at least one substantially smooth metallic layer.

In particular, the invention allows a helically wound honeycomb body to be built up by helically winding up just one, at least partially structured, metallic layer. In this case, the layer may, for example, be structured in one half and smooth in the other half. The layer is folded in the middle and the folded layer is then wound up. It is equally possible for the whole of the metallic layer to be structured and for this layer to then be wound up, in which case it is necessary to ensure that the structures do not slip into one another during the winding operation. This can be ensured, for example, by using small spacers which prevent the structures from slipping into one another. In such a case, the cavities of the honeycomb body are not then delimited by substantially smooth metallic layers and the structures of the at least partially structured layer, but rather are formed solely by the structures of the structured layer.

In accordance with still an additional feature of the invention, the metallic layers, at least in part, and/or at least some of the metallic layers, are composed of a material, preferably a fiber material, through which a fluid can at least partially flow.

This makes it possible in particular to construct particulate filters in which at least some of the cavity walls are constructed from an at least partially structured material through which the fluid can flow. According to the invention, in this context it is possible for the honeycomb body to include metallic layers, some of which are formed by a sheet-metal layer through which fluid substantially cannot flow, if appropriate being perforated at least in parts, while others are formed from material which at least partially allows fluid to flow through it. By way of example, metallic fiber material, in particular sintered metallic fiber material, can be used as a material through which a medium can at least partially flow.

Furthermore, it is equally possible according to the invention to construct a honeycomb body which, as seen in the through-flow direction, has regions, at least some of the cavity walls of which allow a fluid to flow through them, and other regions through which a fluid substantially cannot flow. This can be achieved, for example, by at least some of the metallic layers, as seen in the direction of flow through the honeycomb body, being composed, for example, of two regions, in which case one region is formed from sheet metal and the other region is formed from metallic fiber material. Moreover, by way of example it is also possible according to the invention for a metallic layer of fiber material to be reinforced with sheet-metal strips in subregions.

In accordance with again another feature of the invention, the honeycomb body is at least partially constructed from layers which are at least partially structured with a structure repetition length, and holes, the dimensions of which are at least in some cases larger than the structure repetition length, preferably significantly larger than the structure repetition length, are formed at least in subregions of at least some of the layers.

In this case, it is preferable to use dimensions of the holes which, at least in one spatial direction, are between two and ten times, particularly preferably between two and five times, larger than the structure repetition length. According to the invention it is possible both to introduce substantially round holes and to introduce oval holes which have a first length in a first direction and a second length in a second direction, perpendicular to the first direction, which is a multiple of the first length. Any other desired forms of holes, as well as special orientations of the holes with respect to the direction of flow through the honeycomb body, are also possible and in accordance with the invention.

As a result of the formation of holes with dimensions larger than the structure repetition length in the layers or in some layers, it is possible after the winding or intertwining to form void-like cavities, in which the fluid flow is swirled up as it passes through the honeycomb body. When used, for example, as a catalyst carrier body in the exhaust system of an automobile, this leads to thorough mixing of the exhaust gas and therefore to a good level of catalytic conversion, since laminar boundary flows are avoided in this way.

Furthermore, in this way, the catalyst carrier bodies can be made more lightweight and with a reduced deployment of materials while achieving the same conversion efficiency.

In accordance with again a further feature of the invention, the microstructures, preferably at an angle to the through-flow direction, particularly preferably substantially at a right angle to the through-flow direction, turned-over formations and/or holes with dimensions smaller than the structure repetition length, are formed in at least some of the layers.

The microstructures are distinguished by the fact that their structuring amplitude is smaller, preferably significantly smaller, than the structuring amplitude of the at least partially structured metallic layers. The microstructurings are responsible for swirling up the fluid flow. If a honeycomb body according to the invention is used in the exhaust system of an automobile, for example as a catalyst carrier body, microstructuring of this type ensures thorough mixing of the exhaust gases and prevents laminar boundary flows. It is preferable for these microstructures to be formed at an angle to the through-flow direction, particularly preferably at an angle of 90 degrees. However, other angles are also possible and in accordance with the invention, such as for example 30, 45 or 60 degrees.

In accordance with again an added feature of the invention, there are provided turned-over formations. These are, for example, flow-guiding surfaces which, by interacting with an aperture in the cavity wall, are responsible for exchange of flow between adjacent cavities. This, in addition to diverting the flow of fluid in a cavity, also swirls up the flow, so that laminar boundary flows are avoided or swirled up. Laminar boundary flows are generally undesirable, in particular if the honeycomb body is used in the exhaust system of an automobile. That is because, for example, if the honeycomb body is used as a catalyst carrier body, they reduce the efficiency of conversion. In the case of use, for example, as an adsorber, the adsorption rate is reduced by laminar boundary flows, while in the case of use as a particulate filter, the filtration rate is reduced.

The above-mentioned options for influencing the flow can also be used cumulatively, i.e. for example by combining holes with dimensions larger than the structure repetition length of the structuring with holes having a dimension smaller than the structure repetition length of the structuring or also with turned-over formations and/or microstructuring.

In accordance with again an additional feature of the invention, the honeycomb body is formed from a ceramic material. Forming the honeycomb body from ceramic material is possible in various ways. By way of example, the honeycomb body can be extruded or built up in layers from ceramic powder. Ceramic honeycomb bodies can be used as a catalyst carrier body, as an adsorber body or as a particulate filter in the exhaust system of an automobile, given a suitable structure of the cavity walls and/or a suitable coating.

In accordance with another feature of the invention, the honeycomb body is extruded in form. In this case, in particular, the invention allows for the use of an extruded ceramic or metallic honeycomb body.

A further process for producing honeycomb bodies of this type may include the layered application of a material which can be solidified and is cured repeatedly by temperature or light. In this way it is possible to produce structures of any desired complexity, even with undercuts. This process, derived from rapid prototyping, is already in use in series production in some cases.

With the objects of the invention in view, there is also provided a lambda sensor for installation in a honeycomb body. The lambda sensor comprises a first subregion and a second subregion. The subregions include or enclose an angle other than 180 degrees.

A lambda sensor according to the invention can advantageously be used in a corresponding honeycomb body to monitor the oxygen content in the exhaust gas. For this purpose, the lambda sensor is introduced by way of the second subregion into a corresponding receiving part of the honeycomb body. The angled lambda sensor according to the invention advantageously allows the space-saving construction of a honeycomb body in which the lambda sensor can be used to monitor the oxygen content in the exhaust gas.

In accordance with another feature of the invention, at least one of the subregions is curved. A curved formation of at least one of the two subregions advantageously allows, for example, the shape of the lambda sensor to be matched to a curvature of a honeycomb body.

In accordance with a concomitant feature of the invention, the lambda sensor has a thermally insulating layer, preferably in the region of the first subregion.

Since the first subregion lies outside the tubular casing of the honeycomb body, when the lambda sensor is installed in a honeycomb body, according to the invention an additional thermal insulation, which advantageously protects the lambda sensor from thermal damage, is provided in this case, due to the critical temperature conditions, for example in the exhaust system of an automobile.

The details and advantages which have been described above for a measurement sensor in a honeycomb body apply in the same way to the lambda sensor according to the invention, and vice versa. This means that details and advantages which have been disclosed for the honeycomb body with a measurement sensor are equally disclosed for the lambda sensor, and vice versa.

Other features which are considered as characteristic for the invention are set forth in the appended claims.

Although the invention is illustrated and described herein as embodied in a honeycomb body having at least one space-saving measurement sensor, and a corresponding lambda sensor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

FIG. 1 is a diagrammatic, cross-sectional view of a first exemplary embodiment of a honeycomb body according to the invention;

FIG. 2 is a highly diagrammatic, side-perspective view of the first exemplary embodiment of a honeycomb body according to the invention;

FIG. 3 is a cross-sectional view of a second exemplary embodiment of a honeycomb body according to the invention;

FIG. 4 is a cross-sectional view of a third exemplary embodiment of a honeycomb body according to the invention;

FIG. 5 is a cross-sectional view of a fourth exemplary embodiment of a honeycomb body according to the invention; and

FIG. 6 is a highly-diagrammatic, longitudinal-sectional view of a fifth exemplary embodiment of a honeycomb body according to the invention;

FIG. 7 is a highly-diagrammatic, fragmentary, perspective view of a layer used to create a honeycomb body; and

FIG. 8 is an enlarged, highly-diagrammatic, fragmentary, perspective view of a further layer used to create a honeycomb body.

### DESCRIPTION OF THE PREFERRED EMBODIMENTS

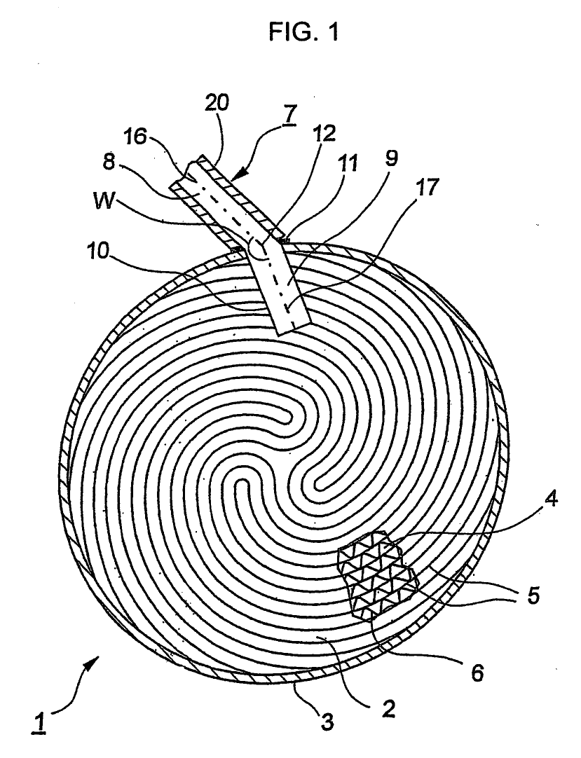

Referring now in detail to the following text which provides an explanation of further advantages and preferred exemplary embodiments of the invention with reference to the figures of the drawing, without the invention being restricted thereto, and first, particularly, to FIG. 1 thereof, there is seen a diagrammatic illustration of a cross section through a honeycomb body 1 according to the invention, which includes a honeycomb structure 2 and a tubular casing 3. The honeycomb structure 2 has cavities 4 through which a fluid can flow and which are formed by substantially smooth metallic layers 5 and at least partially structured, in the present example corrugated, metallic layers 6.

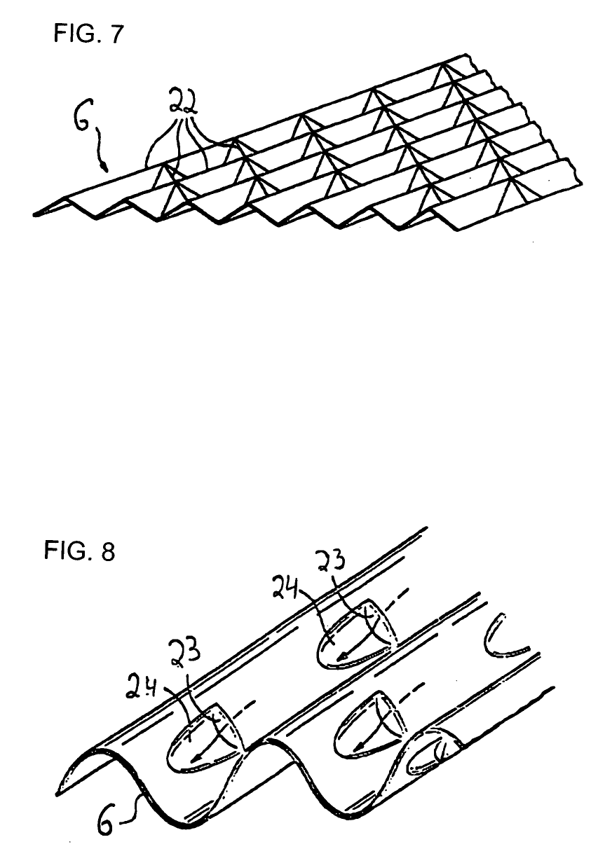

In this context, metallic layers 5, 6 are to be understood in a general sense as meaning layers of metallic material, in particular sheet-metal layers, metallic layers through which a fluid can at least partially flow, for example metallic fiber layers or sintered materials, and combinations thereof, such as for example metallic fiber layers reinforced with sheet-metal strips or sheet-metal regions. Composite material which partially includes ceramic material, for example ceramic fiber material, is also to be understood in the context of the invention as being covered by the term metallic layer. In general, the metallic layers 5, 6 may also be formed from different materials. For example, the substantially smooth layers 5 and/or the at least partially structured metallic layers 6 may in part be formed from sheet-metal layers and in part from metallic and/or ceramic fiber material. The honeycomb bodies which have been constructed in this way can advantageously be used as various components in the exhaust system of an automobile, in particular as catalyst carrier bodies, as adsorber bodies and/or as particulate filters. In the present exemplary embodiment, the metallic layers 5, 6 have been stacked to form three stacks which have been intertwined in involute form. Other forms of winding or intertwining, such as for example an opposite or S-shaped twisting of two stacks or even helically winding up one or more layers 5, 6, are equally possible in accordance with the invention, as is the formation of the honeycomb structure 2 from ceramic or as an extruded metal structure. A plate-like construction of the honeycomb structure 2 from one or more metallic layers, at least some of which are at least partially structured, is also possible in accordance with the invention. The layers 5, 6 are connected to one another, and the honeycomb structure 2 is connected to the tubular casing 3, at least in subregions, by a joining technique, in particular brazing and/or welding. The layers 5, 6 can include microstructures 22 as can be seen in FIG. 7, holes 23 and/or turned-over formations 24 as can be seen in FIG. 8.

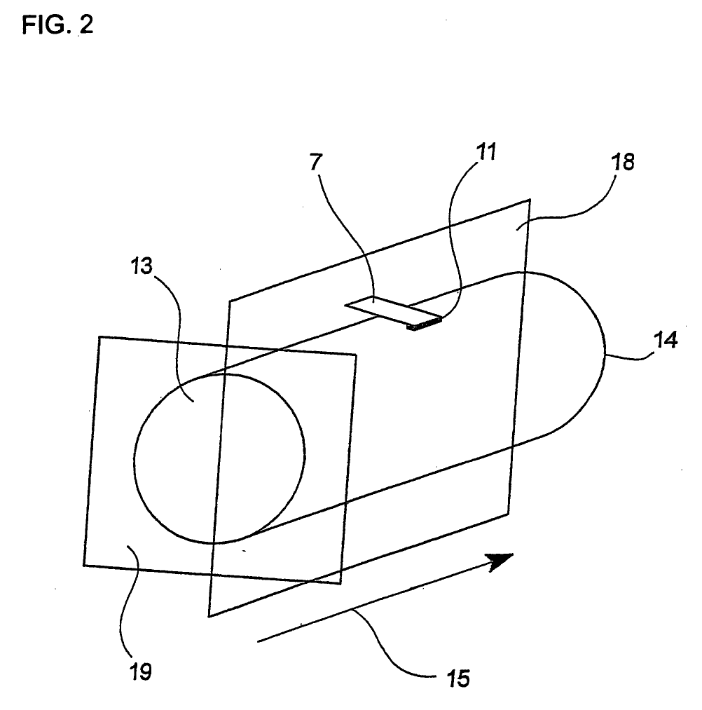

The honeycomb body 1 also has a measurement sensor 7 which includes a first subregion 8 and a second subregion 9. According to the invention, it is also possible to form a plurality of measurement sensors 7. In the present, first exemplary embodiment, the first subregion 8 and the second subregion 9 are each rectilinear in form. In this case, the second subregion 9 is accommodated in a receiving part 10 inside the honeycomb structure 2. This receiving part 10 is formed by a corresponding cavity inside the honeycomb structure 2 and a corresponding connection piece 11 in the tubular casing 3. The second subregion 9 of the measurement sensor 7 is accommodated in this receiving part 10, so that the contact region 12 between first subregion 8 and second subregion 9 of the measurement sensor 7 is formed in the connection piece 11. The first subregion 8 and the second subregion 9 include an angle W in the contact region 12. This angle W is generally in a range of from 60 to 120 degrees, preferably 75 to 105 degrees, particularly preferably 85 to 95 degrees. A further preferred value for the angle W is substantially 90 degrees. The angle W can substantially be defined with reference to two planes, which can be seen in FIG. 2.

FIG. 2 shows a side perspective view of the first exemplary embodiment of the honeycomb body 1 according to the invention. The honeycomb body 1 has a first end side 13 and second end side 14, although the layers 5, 6 and the cavities 4 are not shown for the sake of clarity. If the honeycomb body 1 is installed, for example, in the exhaust system of an automobile, exhaust gas flows through the honeycomb body 1 from the first end side 13 to the second end side 14 in a through-flow direction 15. Depending on the structure of the metallic layers 5, 6, locally different directions of flow of the exhaust gas may be present in the honeycomb structure 2, but this is of no relevance to the through-flow direction 15. However, it is equally possible to provide non-illustrated measures for flow reversal, which effect flow reversal downstream of the second end side 14, so that therefore, a direction of flow in the through-flow direction 15 is present in a subregion of the honeycomb body 1, and a direction of flow that is substantially opposite to the through-flow direction 15 is present in another subregion.

As is seen in FIG. 1, in each case, the angle W can be broken down into two components in two planes in which, for example, a first longitudinal axis 16 of the first subregion 8 and a second longitudinal axis 17 of the second subregion 9, in each case as seen in the contact region 12, are considered as vectors, represented in the form of polar coordinates. A first plane 18 is a plane which encompasses the through-flow direction 15. One possible first plane 18 is shown in FIG. 2. A second plane 19 is the plane for which the vector of the through-flow direction 15 represents the surface normal, i.e. which is perpendicular to the direction of flow 15 through the honeycomb body 1. The second plane 19 is likewise shown in FIG. 2. Therefore, the angle W included by the first subregion 8 and the second subregion 9 lies in the first plane 18 and/or the second plane 19.

In the first exemplary embodiment, shown in FIGS. 1 and 2, the angle W lies only in the second plane 19. If the angle W is divided into a first component W1, which lies in the first plane 18, and a second component W2, which lies in the second plane 19, in the present example the second component W2 would be identical to the angle W, while the first component W1 would be zero.

The measurement sensor 7 is constructed to be rigid in the first subregion 8 and in the second subregion 9. In this context, the term rigid means in particular that the subregions 8, 9 are substantially not deformable and/or elastic by forces such as may occur during installation of the measurement sensor 7 in the honeycomb body 1 or forces as may occur during use of the honeycomb body 1 in the exhaust system of an automobile. The measurement sensor 7 in the present exemplary embodiment is a lambda sensor. As an alternative or in addition, however, the measurement sensor 7 can also record the temperature and/or a proportion of a component of the fluid, such as for example nitrogen oxides (NOₓ) in the exhaust gas from an automobile, as well as any other desired characteristic variables of the flowing fluid.

The honeycomb body 1 according to the invention advantageously allows control of at least one characteristic variable of the fluid flowing through the honeycomb body 1, preferably the exhaust gas from an internal combustion engine of an automobile, while at the same time requiring little space for installation of the honeycomb body 1, for example in the exhaust system of an automobile. This is because of the structure of the measurement sensor 7 which is angled at the angle W and therefore takes up considerably less installation space than an unangled, i.e. rectilinear, measurement sensor. Due to the angled structure of the measurement sensor 7, the first subregion 8 is formed considerably closer to the tubular casing 3 than in the case of an unangled structure. If the honeycomb body 1 is installed in an exhaust system of an internal combustion engine, the high temperatures of the exhaust gases generally impose high demands on the thermal stability of the materials being used, which are exacerbated by the angled structure of the measurement sensor 7. A further increase in the temperature, as well as thermal gradients and/or transients also result, in addition to the pulsed occurrence of the exhaust gas, if the honeycomb body 1 is used as a catalyst carrier body, due to the exothermic nature of the catalytic conversions. Since the first subregion 8, due to the angled structure, is located closer to the tubular casing 3 and is therefore exposed to higher temperatures, a thermal insulation 20 is formed from known heat-resistant and/or thermally insulating materials. This thermal insulation 20 advantageously prevents thermal damage to the measurement sensor 7, in particular the first subregion 8.

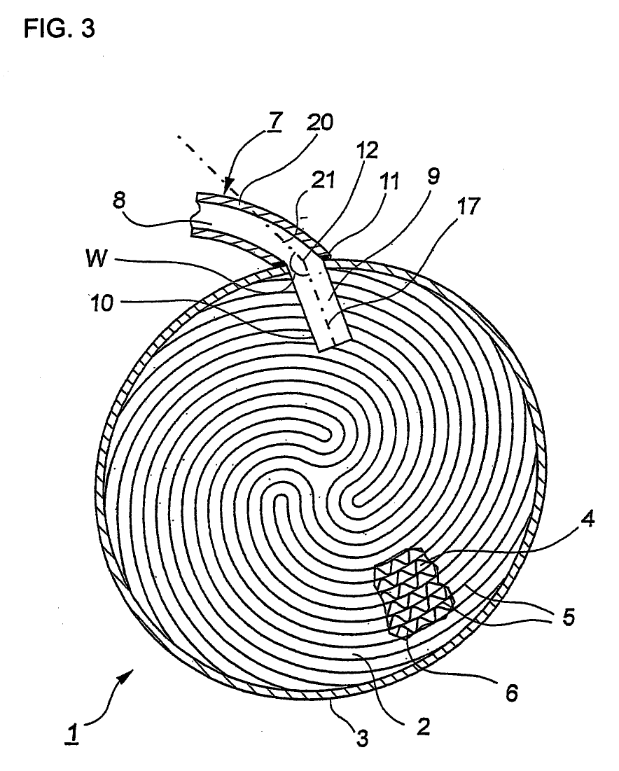

FIG. 3 diagrammatically depicts a cross section through a second exemplary embodiment of a honeycomb body 1 according to the invention, without any details as to the construction of the honeycomb structure 2, since the latter is identical to the first exemplary embodiment. In this exemplary embodiment and in those which follow, for the sake of clarity, no description is given of details which are identical to those of the first exemplary embodiment, and therefore in the following text reference is made to the description disclosed above. In the second exemplary embodiment, the first subregion 8 of the measurement sensor 7 is curved in shape. In the contact region 12, there is once again an angle W which is formed by a tangent 21 of the first subregion 8 in the contact region 12 and the second axis 17 of the second subregion 9. In the second exemplary embodiment, the angle W is formed in the second plane 19.

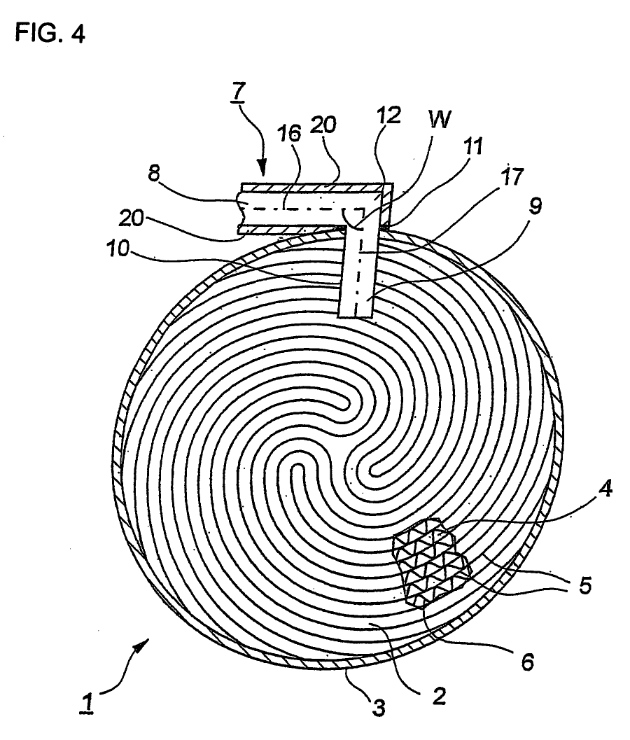

FIG. 4 diagrammatically depicts a cross section through a third exemplary embodiment of a honeycomb body 1 according to the invention. In this embodiment, both the first subregion 8 and the second subregion 9 are rectilinear in form. The two subregions 8, 9 are connected in the contact region 12, in which they include the angle W, which in the third exemplary embodiment amounts to substantially 90 degrees. In the third exemplary embodiment, the angle W is located in the second plane 19. An angle W of substantially 90 degrees particularly advantageously allows a very space-saving construction of the honeycomb body 1 and the measurement sensor 7.

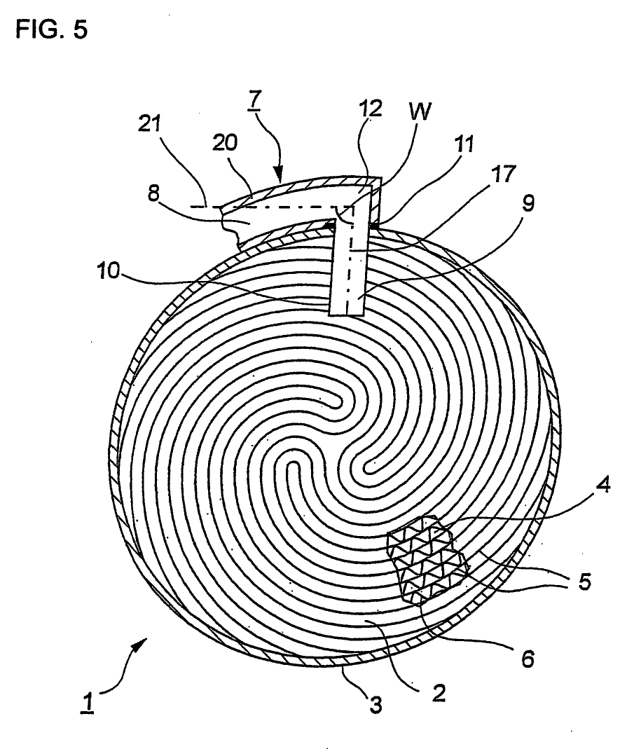

FIG. 5 diagrammatically depicts a cross section through a fourth exemplary embodiment of a honeycomb body 1 according to the invention, including a honeycomb structure 2 and a tubular casing 3. In the honeycomb body 1 there is a measurement sensor 7 which has a first subregion 8 and second subregion 9, that are connected in a contact region 12. The first subregion 8 is curved in form, with the curvature of the first subregion 8 corresponding to the curvature of the tubular casing 3 in the region where the first subregion 8 bears against it. The angle W which is included by the tangent 21 of the first subregion 8 in the region of contact 12 and the second axis 17 of the second subregion 9 amounts to substantially 90 degrees. This, in conjunction with the curvature of the first subregion 8, effects a particularly space-saving structure of the honeycomb body 1 with the measurement sensor 7.

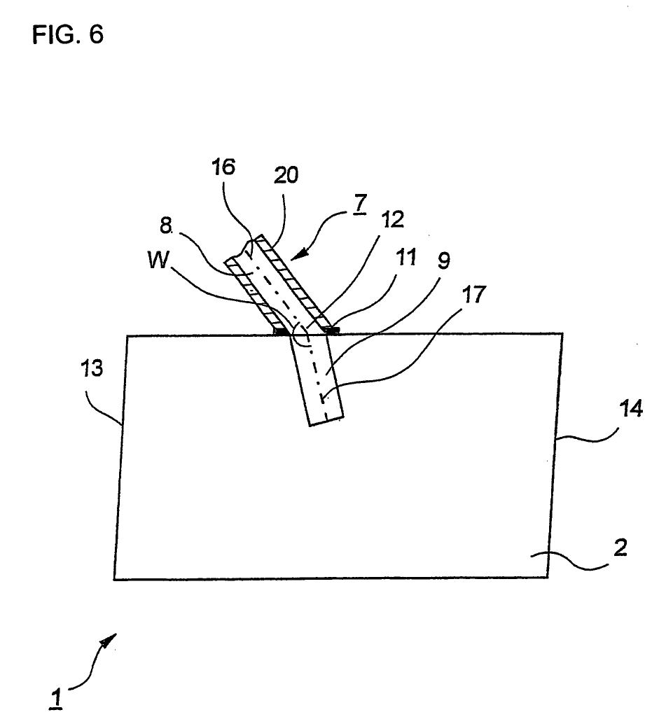

FIG. 6 diagrammatically depicts a longitudinal section through a fifth exemplary embodiment of a honeycomb body 1 according to the invention. The honeycomb body 1 has a first end side 13 and a second end side 14, through which exhaust gas can flow through the honeycomb body 1 in the through-flow direction 15. A measurement sensor 7 is formed in the honeycomb body 1, with a first subregion 8 lying outside the honeycomb body 1, i.e. outside the tubular casing 2, and a second subregion 9 lying inside the honeycomb structure 2.

In the contact region 12, the first subregion 8 and the second subregion 9 include an angle W which lies in the first plane 18. As explained above, this first plane 18 encompasses the direction of flow 15 through the honeycomb body 1.

The exemplary embodiments shown herein each have angles W which lie either only in the first plane 18 or only in the second plane 19. However, according to the invention, it is equally possible for the first subregion 8 and the second subregion 9 to encompass an angle W which lies in both the first plane 18 and the second plane 19.

A honeycomb body 1 according to the invention, by virtue of the angled construction of the measurement sensor 7, advantageously allows very space-saving installation of the honeycomb body 1 with the at least one measurement sensor 7.

We claim:

1. A honeycomb body, comprising:
a tubular casing;
a honeycomb structure through which a fluid can at least partially flow in a through-flow direction, said honeycomb structure being accommodated in said tubular casing and defining a plurality of cavities through which the fluid can at least partially flow;
said through-flow direction defining a first plane encompassing said through-flow direction and a second plane perpendicular to said through-flow direction;
at least one measurement sensor having at least a first substantially rigid subregion and a second substantially rigid subregion, at least said second subregion extending into said honeycomb structure and at least partially penetrating through at least some of said cavities, and at least said first subregion extending outside said tubular casing; and
said first subregion and said second subregion including an angle other than 180 degrees in at least one of said first and second planes.

2. The honeycomb body according to claim 1, wherein the fluid is an exhaust gas from an internal combustion engine.

3. The honeycomb body according to claim 1, wherein said at least one measurement sensor is a lambda sensor.

4. The honeycomb body according to claim 1, wherein said at least one measurement sensor records at least one characteristic variable of the fluid selected from the group consisting of:
a) temperature; and
b) proportion of at least one component of the fluid.

5. The honeycomb body according to claim 1, wherein said at least one measurement sensor has a device for impeding heat conduction.

6. The honeycomb body according to claim 1, wherein said angle included by said first subregion and said second subregion is between 60 and 120 degrees.

7. The honeycomb body according to claim 1, wherein said angle included by said first subregion and said second subregion is between 75 and 105 degrees.

8. The honeycomb body according to claim 1, wherein said angle included by said first subregion and said second subregion is between 85 and 95 degrees.

9. The honeycomb body according to claim 1, wherein said angle included by said first subregion and said second subregion is substantially 90 degrees.

10. The honeycomb body according to claim 1, wherein at least one of said subregions of said at least one measurement sensor is at least partially curved.

11. The honeycomb body according to claim 10, wherein a curvature of said at least partially curved subregion is matched to a curvature of said honeycomb structure.

12. The honeycomb body according to claim 10, wherein a curvature of said at least partially curved subregion is matched to a curvature of said honeycomb structure and to geometric conditions in said honeycomb structure.

13. The honeycomb body according to claim 10, wherein a curvature of said at least partially curved subregion is matched to geometric conditions in said honeycomb structure.

14. The honeycomb body according to claim 1, wherein said honeycomb structure is at least partially formed from at least one metallic layer.

15. The honeycomb body according to claim 1, wherein said honeycomb structure is constructed from a plurality of at least partially structured metallic layers and substantially smooth metallic layers, being stacked and wound or intertwined.

16. The honeycomb body according to claim 1, wherein said honeycomb structure is wound from at least one at least partially structured metallic layer.

17. The honeycomb body according to claim 1, wherein said honeycomb structure is wound from at least one at least partially structured metallic layer and at least one substantially smooth metallic layer.

18. The honeycomb body according to claim 14, wherein said at least one metallic layer is at least in part composed of a material through which a fluid can at least partially flow.

19. The honeycomb body according to claim 18, wherein said material is a fiber material.

20. The honeycomb body according to claim 14, wherein said at least one metallic layer is a plurality of metallic layers, and at least some of said metallic layers are composed of a material through which a fluid can at least partially flow.

21. The honeycomb body according to claim 20, wherein said material is a fiber material.

22. The honeycomb body according to claim 1, wherein:
said honeycomb structure is at least partially composed of metallic layers being at least partially structured and having a structure repetition length; and
at least some of said layers have holes formed at least in subregions thereof, said holes having dimensions being at least in some cases larger than said structure repetition length.

23. The honeycomb body according to claim 22, wherein said holes have dimensions being at least in some cases significantly larger than said structure repetition length.

24. The honeycomb body according to claim 1, wherein:
said honeycomb structure is at least partially composed of metallic layers being at least partially structured and having a structure repetition length; and
at least some of said layers have at least one flow diverter selected from the group consisting of microstructures, turned-over formations and holes with dimensions smaller than said structure repetition length.

25. The honeycomb body according to claim 24, wherein said microstructures are disposed at an angle to said through-flow direction.

26. The honeycomb body according to claim 24, wherein said microstructures are disposed at a right angle to said through-flow direction.

27. The honeycomb body according to claim 1, wherein the honeycomb body is formed from a ceramic material.

28. The honeycomb body according to claim 27, wherein the honeycomb body is extruded.

29. The honeycomb body according to claim 1, wherein the honeycomb body is-extruded.

30. A lambda sensor for installation in a honeycomb body, the lambda sensor comprising:
a first subregion and a second subregion configured to be at least partly disposed at the honeycomb body;
said subregions including an angle other than 180 degrees.

31. The lambda sensor according to claim 30, wherein at least one of said subregions is curved.

32. The lambda sensor according to claim 30, which further comprises a thermally insulating layer.

33. The lambda sensor according to claim 32, wherein said thermally insulating layer is in vicinity of said first subregion.
